(19) United States
(12) Patent Application Publication
(10) Pub. No.: US 2024/0070288 A1
(43) Pub. Date: Feb. 29, 2024

(54) MULTI-LAYERED GRAPH MODELING FOR SECURITY RISK ASSESSMENT

(71) Applicant: International Business Machines Corporation, Armonk, NY (US)

(72) Inventors: Sandhya Koteshwara, White Plains, NY (US); Lars Schneidenbach, Bedford Hills, NY (US); Eun Kyung Lee, Bedford Corners, NY (US)

(21) Appl. No.: 17/823,923

(22) Filed: Aug. 31, 2022

(51) Int. Cl. G06F 21/57; G06F 21/54; G06F 21/55

(52) U.S. Cl. CPC G06F 21/577; G06F 21/54; G06F 21/554

(57) ABSTRACT

One embodiment of the invention provides a method comprising identifying hardware and software components of a system architecture, and generating a multi-layered graph based on the hardware and software components. The multi-layered graph includes a hardware layer representing a lowest level of hardware architecture of the system architecture. The method further comprises extracting one or more properties of the multi-layered graph, computing one or more security metrics based on the one or more properties, and quantifying a security risk of the system architecture based on the one or more security metrics.

### BACKGROUND

The field of embodiments of the invention generally relate to security risk assessment.

A cloud service provider maintains a complex underlying infrastructure to manage complex cloud hardware and/or software components. The infrastructure provides many services such as, but not limited to, a security service, a computing service, a networking service, a storage service, a telemetry service, a resource management service, etc. Providing many services results in a high number of potential attack surfaces with regards to security. With such a high number of attack surfaces, it becomes hard to analyze security aspects of the infrastructure. Further, conventional solutions for security risk assessment analyze security risk of hardware (components and assembly) and software (library/package dependencies) separately.

### SUMMARY

Embodiments of the invention generally relate to security risk assessment, and more specifically, to multi-layered graph modeling for security risk assessment.

One embodiment of the invention provides a method comprising identifying hardware and software components of a system architecture, and generating a multi-layered graph based on the hardware and software components. The multi-layered graph includes a hardware layer representing a lowest level of hardware architecture of the system architecture. The method further comprises extracting one or more properties of the multi-layered graph, computing one or more security metrics based on the one or more properties, and quantifying a security risk of the system architecture based on the one or more security metrics. Other embodiments include a system for security risk analysis, and a computer program product for security risk analysis. These features contribute to the advantage of linking analysis of supply chain security of hardware (components and assembly) and software (library/package dependencies), allowing system administrators to see how hardware supply chain attack affects software, or how effects of software supply chain attack could be mitigated in hardware.

One or more of the following features may be included.

In some embodiments, the security risk of the system architecture is compared against one or more other security risks of one or more other system architectures.

In some embodiments, the multi-layered graph comprises one or more vertices representing the hardware and software components, one or more edges representing actual or possible interactions between the hardware and software components, and one or more layers representing one or more levels of abstraction of the hardware and software components. For example, in some embodiments, the multi-layered graph includes additional layers such as one or more network interface card (NIC)/hardware (HW) layers and one or more isolation layers, thereby modeling hardware and isolation layers of the system architecture. A hardware layer bridges a time scale gap between security risk analysis of slow, hard to change hardware and quickly evolving software, and addresses the intersection of hardware and software at times when complex systems are designed, implemented or deployed.

In some embodiments, one or more vulnerabilities and one or more countermeasures of the system architecture are identified. The one or more vulnerabilities comprise at least one of the vertices representing a potential attack surface and at least one of the edges representing a potential attack path. In some embodiment, the one or more security metrics are reassessed after the one or more vulnerabilities and the one or more countermeasures are identified.

In some embodiments, the security risk analysis is automated.

These and other aspects, features and advantages of embodiments of the invention will be understood with reference to the drawing figures, and detailed description herein, and will be realized by means of the various elements and combinations particularly pointed out in the appended claims. It is to be understood that both the foregoing general description and the following brief description of the drawings and detailed description of embodiments of the invention are exemplary and explanatory of preferred embodiments of the invention, and are not restrictive of embodiments of the invention, as claimed.

### BRIEF DESCRIPTION OF THE DRAWINGS

The subject matter which is regarded as embodiments of the invention are particularly pointed out and distinctly claimed in the claims at the conclusion of the specification. The foregoing and other objects, features, and advantages of embodiments of the invention are apparent from the following detailed description taken in conjunction with the accompanying drawings in which:

FIG. 1 depicts a computing environment according to an embodiment of the present invention;

FIG. 2 illustrates an example computing architecture for implementing graph-based security risk assessment, in accordance with an embodiment of the invention;

FIG. 3 illustrates an example multi-layered graph modeling system in detail, in accordance with an embodiment of the invention;

FIG. 4 illustrates an example multi-layered graph modeling underlying infrastructure (i.e., architecture) of a complex system, in accordance with an embodiment of the invention;

FIG. 5A illustrates an example conventional graph modeling underlying infrastructure (i.e., architecture) of a complex system;

FIG. 5B illustrates another example multi-layered graph modeling underlying infrastructure (i.e., architecture) of a complex system, in accordance with an embodiment of the invention;

FIG. 6 illustrates different graphs modeling different complex systems and different exploitability scores for the complex system, in accordance with an embodiment of the invention; and

FIG. 7 is a flowchart for an example process for implementing multi-layered graph modeling for security risk assessment, in accordance with an embodiment of the invention.

The detailed description explains the preferred embodiments of the invention, together with advantages and features, by way of example with reference to the drawings.

### DETAILED DESCRIPTION

Embodiments of the invention generally relate to security risk assessment, and more specifically, to multi-layered graph modeling for security risk assessment. One embodiment of the invention provides a method comprising identifying hardware and software components of a system architecture, and generating a multi-layered graph based on the hardware and software components. The multi-layered graph includes a hardware layer representing a lowest level of hardware architecture of the system architecture. The method further comprises extracting one or more properties of the multi-layered graph, computing one or more security metrics based on the one or more properties, and quantifying a security risk of the system architecture based on the one or more security metrics.

Another embodiment of the invention provides a system for security risk analysis. The system comprises at least one processor and a non-transitory processor-readable memory device storing instructions that when executed by the at least one processor causes the at least one processor to perform operations. The operations include identifying hardware and software components of a system architecture, and generating a multi-layered graph based on the hardware and software components. The multi-layered graph includes a hardware layer representing a lowest level of hardware architecture of the system architecture. The operations further include extracting one or more properties of the multi-layered graph, computing one or more security metrics based on the one or more properties, and quantifying a security risk of the system architecture based on the one or more security metrics.

One embodiment of the invention provides a computer program product for security risk analysis. The computer program product comprises a computer readable storage medium having program instructions embodied therewith. The program instructions are executable by a processor to cause the processor to identify hardware and software components of a system architecture, and generate a multi-layered graph based on the hardware and software components. The multi-layered graph includes a hardware layer representing a lowest level of hardware architecture of the system architecture. The program instructions are executable by the processor to further cause the processor to extract one or more properties of the multi-layered graph, compute one or more security metrics based on the one or more properties, and quantify a security risk of the system architecture based on the one or more security metrics.

For expository purposes, the terms “complex system” and “system architecture” are used interchangeably in this specification.

One or more embodiments provide a framework for graph-based security risk analysis for a complex system (e.g., cloud system, edge system). In one embodiment, the framework provides a graph that represents hardware and/or software components of the complex system as vertices, and actual or possible interactions between the hardware and/or software components as edges. The graph allows system administrators to understand potential attack surfaces and potential attack paths of the complex system.

In one embodiment, the graph is multi-layered. Each layer of the graph is modularized and represents a self-contained level of abstraction (hardware and/or software). The graph is extendible to larger complex systems.

In one embodiment, one or more properties of the graph are indicative of one or more vulnerabilities of the complex system. For example, security risk of the complex system may be quantified based on a common vulnerability scoring system that factors into account security metrics such as, but not limited to, exploitability score, impact score, etc.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

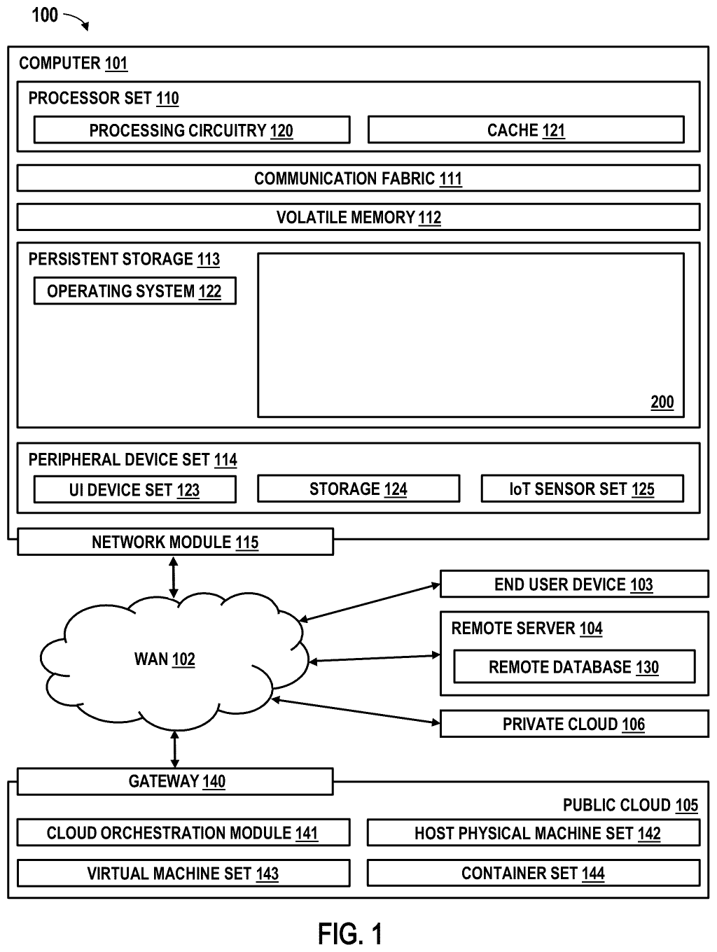

FIG. 1 depicts a computing environment 100 according to an embodiment of the present invention. Computing environment 100 contains an example of an environment for the execution of at least some of the computer code involved in performing the inventive methods, such as multi-layered graph modeling for security risk assessment 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

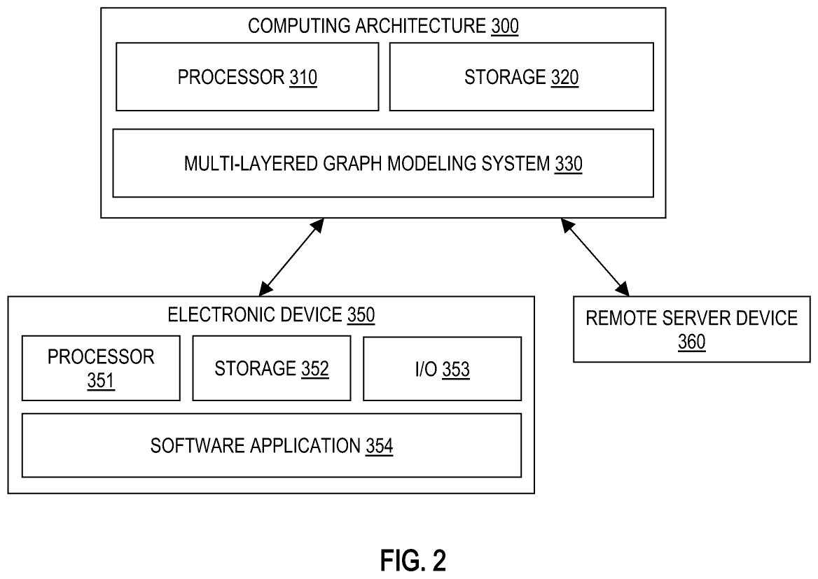

FIG. 2 illustrates an example computing architecture 300 for implementing graph-based security risk assessment, in accordance with an embodiment of the invention.

In one embodiment, the computing architecture 300 comprises computation resources such as, but not limited to, one or more processor units 310 and one or more storage units 320. One or more applications may execute/operate on the computing architecture 300 utilizing the computation resources of the computing architecture 300. In one embodiment, the applications on the computing architecture 300 include, but are not limited to, a multi-layered graph modeling system 330 for security risk assessment. As described in detail later herein, the system 330 is configured to: (1) perform a security risk assessment of underlying infrastructure (i.e., architecture) of a complex system, such as a cloud system, and (2) formulate/generate a graph indicative of the security risk assessment. In one embodiment, the graph comprises at least: (1) one or more vertices representing one or more hardware and/or software components of the complex system, and (2) one or more edges connecting the one or more vertices, wherein the one or more edges represent one or more actual or possible interactions between the hardware and/or software components. The graph provides system administrators with a visual representation that identifies one or more potential attack surfaces and one or more potential attack paths of the complex system.

In one embodiment, the system 330 provides multi-layered modeling of the complex system. For example, in one embodiment, the graph is multi-layered. Each layer of the graph is modularized, and the multiple layers of the graph represent self-contained levels of abstraction that the hardware and/or software components are defined into. In one embodiment, the graph is extendible to larger complex systems.

In one embodiment, one or more properties of the graph are indicative of one or more vulnerabilities of the complex system. For example, security risk of the complex system may be quantified based on a common vulnerability scoring system that factors into account scores such as, but not limited to, exploitability score, impact score, etc.

In one embodiment, the system 330 is configured to exchange data with one or more electronic devices 350 and/or one or more remote server devices 360 over a connection (e.g., a wireless connection such as a Wi-Fi connection or a cellular data connection, a wired connection, or a combination of the two).

In one embodiment, an electronic device 350 comprises one or more computation resources such as, but not limited to, one or more processor units 351 and one or more storage units 352. One or more applications may execute/operate on an electronic device 350 utilizing the one or more computation resources of the electronic device 350 such as, but not limited to, one or more software applications 354 loaded onto or downloaded to the electronic device 350. Examples of software applications 354 include, but are not limited to, system administration applications, etc.

Examples of an electronic device 350 include, but are not limited to, a desktop computer, a mobile electronic device (e.g., a tablet, a smart phone, a laptop, etc.), a wearable device (e.g., a smart watch, etc.), an Internet of Things (IoT) device, etc.

In one embodiment, an electronic device 350 comprises one or more input/output (I/O) units 353 integrated in or coupled to the electronic device 350, such as a keyboard, a keypad, a touch interface, a display screen, etc. A user (e.g., system administrator, a domain specialist) may utilize an I/O module 353 of an electronic device 350 to configure one or more user preferences, configure one or more parameters, provide input (e.g., validate a graph), etc.

In one embodiment, the system 330 may be accessed or utilized by one or more online services (e.g., system administration services) hosted on a remote server device 360 and/or one or more software applications 354 (e.g., system administration applications) operating on an electronic device 350. For example, in one embodiment, a software application 354 operating on an electronic device 350 can invoke the system 330 to perform a security risk assessment.

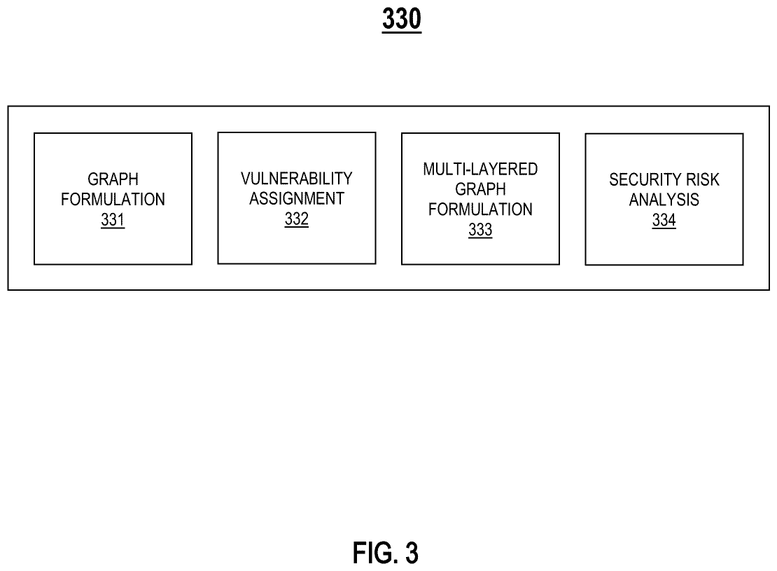

FIG. 3 illustrates an example multi-layered graph modeling system 330 in detail, in accordance with an embodiment of the invention. In one embodiment, the system 330 comprises a graph formulation unit 331 configured to formulate/generate a graph modeling underlying infrastructure (i.e., architecture) of a complex system based on hardware and/or software components of the complex system. Let G generally denote a graph formulated/generated by the system 330, let V generally denote one or more vertices included in the graph G, and let E generally denote one or more edges included in the graph G, wherein G=(V, E). The unit 331 is configured to map hardware and/or software components of the complex system that represent potential attack surfaces to vertices V of the graph G. The unit 331 is further configured to map actual or possible interactions between the hardware and/or software components that represent potential attack paths to edges E of the graph G.

In one embodiment, the system 330 comprises a vulnerability assignment unit 332 configured to assign, for each vertex of the graph G, a corresponding vulnerability probability indicative of a likelihood of an attack at the vertex.

In one embodiment, the system 330 comprises a multi-layered graph formulation unit 333 configured to formulate/generate a multi-layered graph of the complex system by defining one or more sub-sections of the graph G into one or more layers D, resulting in the multi-layered graph G=(V, E, D). The unit 333 is configured to map one or more levels of hardware and/or software components of the complex system to the one or more layers D. For example, in one embodiment, the unit 333 maps a lowest level of hardware architecture (e.g., subcomponents and buses) to a lowest layer of the graph G, and further maps operating system (OS)/middleware/networking architecture and applications/services architecture to higher layers of the graph G.

The unit 333 is further configured to trace flow of data (i.e., actual or possible interactions) in the higher layers of the graph G to the lowest layer of the graph G, and map the flow of data to the one or more edges E. The combination of hardware interconnections and the data flow represented by the graph G facilitates determination/identification of all potential attack paths from a source node to a target node of the graph G.

In one embodiment, the system 330 comprises a security risk analysis unit 334 configured to analyze one or more potential attack paths (“path analysis”) and compute/define one or more security metrics of the complex system over the multi-layered structure of the graph G, thereby removing the need to convert the component-centric graph G to an event-centric graph. The unit 334 takes into account multiple layers of the complex system including the lowest level of the hardware architecture to compute/define the security metrics. In one embodiment, the unit 334 is configured to flatten the sub-sections defining the layers D to perform the path analysis and compute/define the security metrics. In one embodiment, the unit 334 is configured to flatten and either fully aggregate or partially aggregate one or more subcomponents or layers of the graph G into aggregated vertices to reduce complexity or change the focus of the security risk analysis.

In one embodiment, the unit 334 is configured to implement a common vulnerability scoring system that quantifies security risk of the complex system. For example, in one embodiment, the scoring system includes computing/determining an exploitability score and/or an impact score of the complex system based on each vulnerability probability corresponding to each vertex of the graph G.

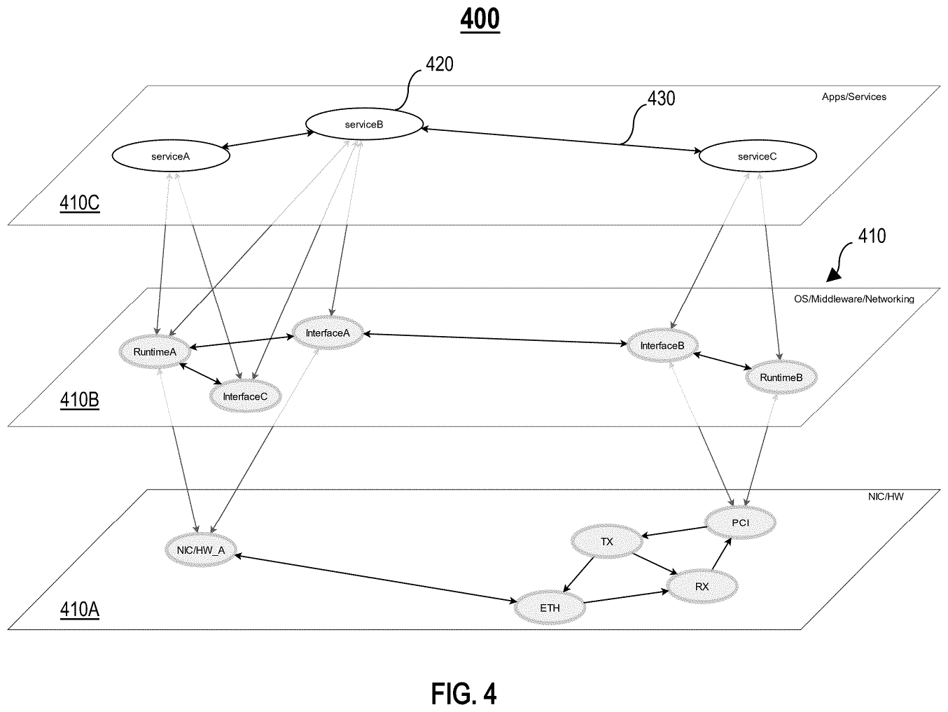

FIG. 4 illustrates an example multi-layered graph 400 modeling underlying infrastructure (i.e., architecture) of a complex system, in accordance with an embodiment of the invention. The graph 400 comprises multiple layers 410. Each layer 410 represents a self-contained level of abstraction of hardware and/or software components, and comprises vertices 420 representing the hardware and/or software components.

The system 330 is configured to map one or more levels of hardware and/or software architecture of the complex system to one or more layers 410 of the graph 400. As shown in FIG. 4, in one embodiment, the system 330 maps at least the following: (1) a lowest level of hardware architecture (e.g., subcomponents and buses) of the complex system to a first layer 410A of the graph 400, (2) operating system (OS)/middleware/networking architecture of the complex system to a second layer 410B of the graph 400, and (3) applications/services architecture to a third layer 410C of the graph 400. The first layer 410A is the lowest layer of the graph 400, and the second layer 410B and the third layer 410C are higher layers of the graph 400.

The system 330 is further configured to trace flow of data in the higher layers 410 (e.g., layers 410B, 410C) of the graph 400 to the lowest layer 410A of the graph 400, and map the flow of data to one or more edges 430 of the graph 400.

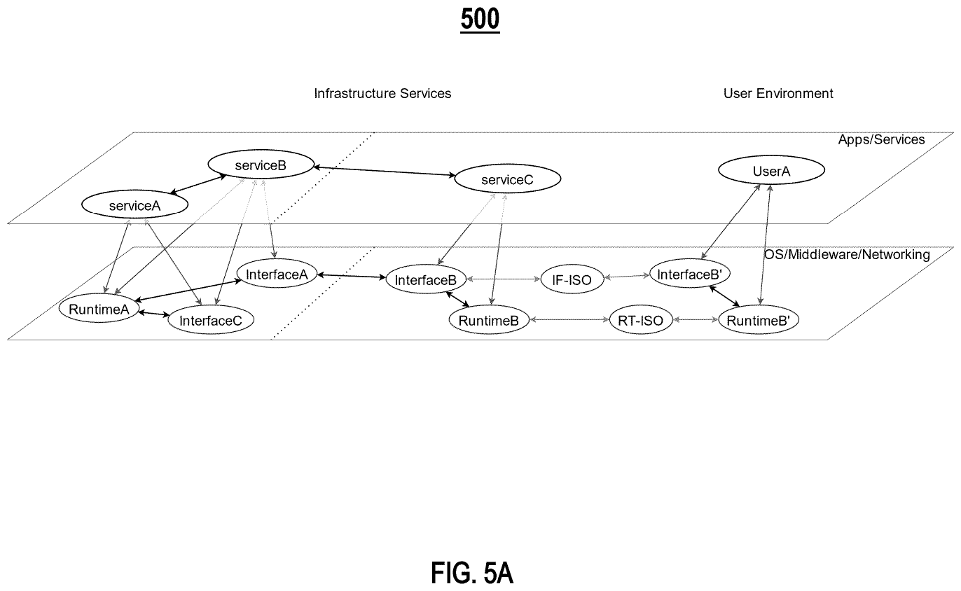

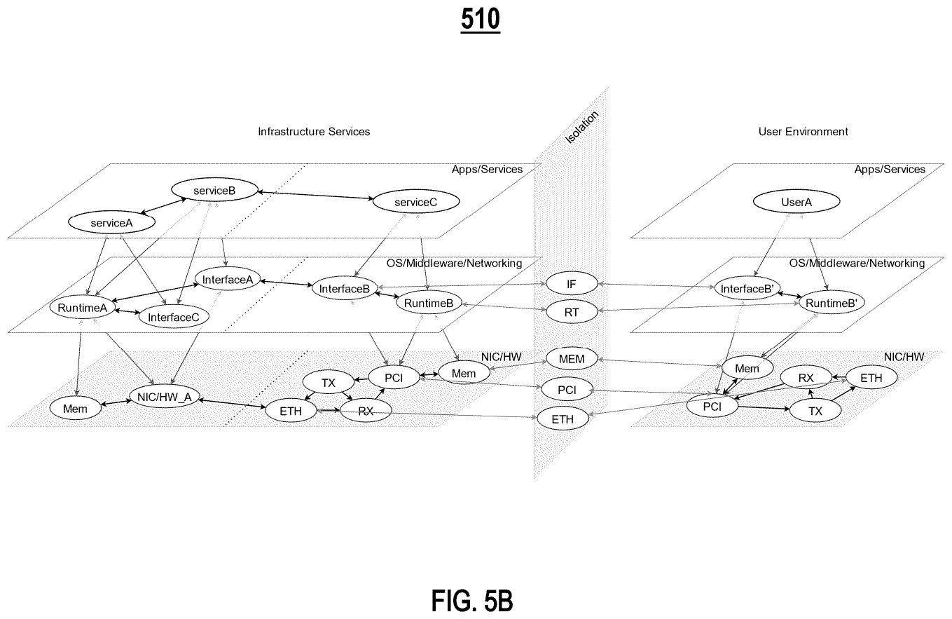

FIG. 5A illustrates an example conventional graph 500 modeling underlying infrastructure (i.e., architecture) of a complex system. As shown in FIG. 5A, conventional methods for security risk assessment analyze security risk at application and OS levels of the complex system only, such that isolation is spread out on certain nodes (labeled with the suffix “-ISO”) of the graph 500, and hardware architecture of the complex system is analyzed separately.

FIG. 5B illustrates another example multi-layered graph 510 modeling underlying infrastructure (i.e., architecture) of a complex system, in accordance with an embodiment of the invention. Unlike the conventional graph 500, the graph 510 includes additional layers such as one or more network interface card (NIC)/hardware (HW) layers, and an isolation layer. The system 330 models hardware and isolation layers of a complex system.

A hardware layer bridges a time scale gap between security risk analysis of slow, hard to change hardware and quickly evolving software, and addresses the intersection of hardware and software at times when complex systems are designed, implemented or deployed. For example, conventional methods for security risk analysis analyze supply chain security of hardware (components and assembly) and software (library/package dependencies) separately. By comparison, the system 330 linking both analysis, allowing system administrators to see how hardware supply chain attack affects software, or how effects of software supply chain attack could be mitigated in hardware.

An isolation layer simplifies and consolidates how isolation is addressed in a complex system, allowing for cutting across multiple layers to ensure true isolation (as opposed to including dispersed isolation nodes, as shown in FIG. 5A). The system 330 provides better graph scalability compared to dispersed isolation nodes by allowing to focus on aspects of interest.

The system 330 analyzes impact on security risk caused by alterations to a complex system which changes structure of a multi-layered graph modeling the complex system, such as changes to vertex properties (e.g., changes to vulnerability properties). The system 330 may be used to compare security risks of different complex systems.

In one embodiment, graph generation and security risk assessment implemented by the system 330 are automated, resulting in automated secure architecture analysis.

The system 330 allows for secure design choices during hardware design, avoids the spending of resources on implementing inherently less secure designs, is implementable as part of CI/CD pipeline, may be converted to an automated tool, may be used to assess several internal system architectures (e.g., SmartNIC packet processing, cloud control system), and may be incorporated as part of a security risk management framework.

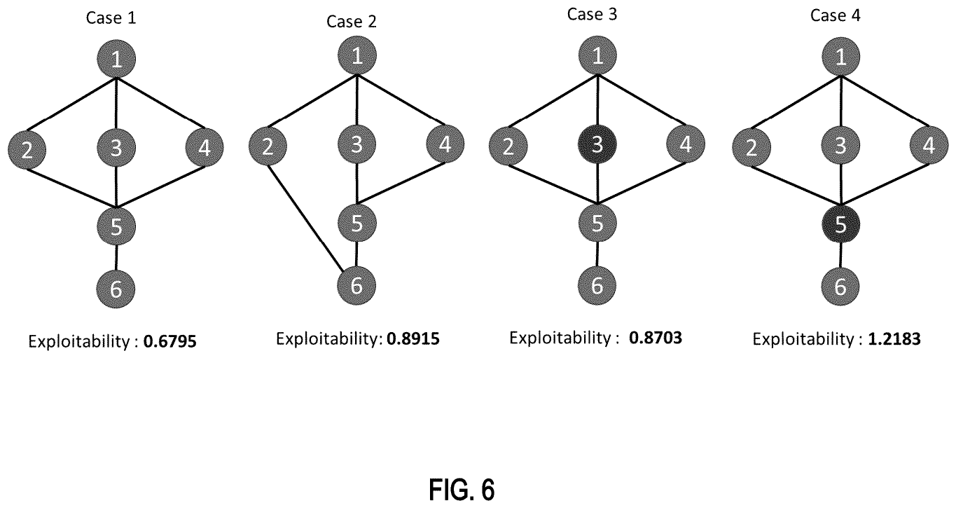

FIG. 6 illustrates different graphs modeling different complex systems and different exploitability scores for the complex system, in accordance with an embodiment of the invention. Each of Case 1, Case 2, Case 3, and Case 4 is a graph modeling a complex system, wherein node 1 of the graph is a critical node, and node 6 of the graph is an attacker node. If each node of Case 1 has a corresponding vulnerability score of 0.5, the system 330 computes an exploitability score of 0.6795 for a complex system modeled by Case 1. If each node of Case 2 has a corresponding vulnerability score of 0.5, the system 330 computes an exploitability score of 0.8915 for a complex system modeled by Case 2. If node 3 of Case 3 has a corresponding vulnerability score of 0.95 and each remaining node of Case 3 has a corresponding vulnerability score of 0.5, the system 330 computes an exploitability score of 0.8703 for a complex system modeled by Case 3. If node 5 of Case 4 has a corresponding vulnerability score of 0.95 and each remaining node of Case 4 has a corresponding vulnerability score of 0.5, the system 330 computes an exploitability score of 1.2183 for a complex system modeled by Case 4.

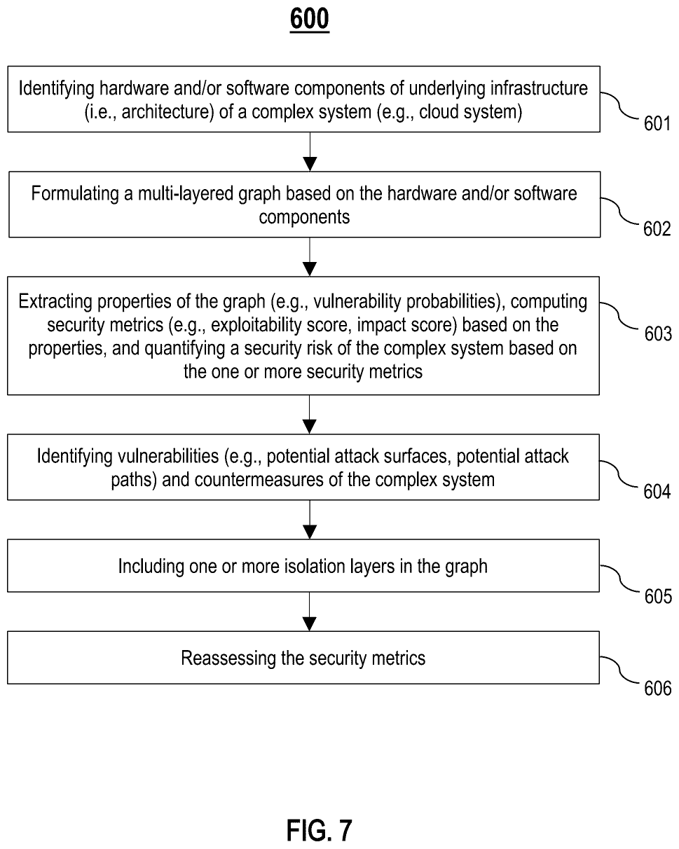

FIG. 7 is a flowchart for an example process 600 for implementing multi-layered graph modeling for security risk assessment, in accordance with an embodiment of the invention. Process block 601 includes identifying hardware and/or software components of underlying infrastructure (i.e., architecture) of a complex system (e.g., cloud system). Process block 602 includes formulating a multi-layered graph based on the hardware and/or software components. Process block 603 includes extracting properties of the graph (e.g., vulnerability probabilities), computing security metrics (e.g., exploitability score, impact score) based on the properties, and quantifying a security risk of the complex system based on the one or more security metrics. Process block 604 includes identifying vulnerabilities (e.g., potential attack surfaces, potential attack paths) and countermeasures of the complex system. Process block 605 includes including one or more isolation layers in the graph. Process block 606 includes reassessing the security metrics.

In one embodiment, process blocks 601-606 are performed by one or more components of the system 330.

From the above description, it can be seen that embodiments of the invention provide a system, computer program product, and method for implementing the embodiments of the invention. Embodiments of the invention further provide a non-transitory computer-useable storage medium for implementing the embodiments of the invention. The non-transitory computer-useable storage medium has a computer-readable program, wherein the program upon being processed on a computer causes the computer to implement the steps of embodiments of the invention described herein. References in the claims to an element in the singular is not intended to mean “one and only” unless explicitly so stated, but rather “one or more.” All structural and functional equivalents to the elements of the above-described exemplary embodiment that are currently known or later come to be known to those of ordinary skill in the art are intended to be encompassed by the present claims. No claim element herein is to be construed under the provisions of 35 U.S.C. 112(f), unless the element is expressly recited using the phrase “means for” or “step for.”

The terminology used herein is for the purpose of describing particular embodiments of the invention only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed.

The descriptions of the various embodiments of the invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for security risk analysis, comprising:
identifying hardware and software components of a system architecture;
generating a multi-layered graph based on the hardware and software components, wherein the multi-layered graph includes a hardware layer representing a lowest level of hardware architecture of the system architecture;
extracting one or more properties of the multi-layered graph;
computing one or more security metrics based on the one or more properties; and
quantifying a security risk of the system architecture based on the one or more security metrics.

2. The method of claim 1, further comprising:
comparing the security risk of the system architecture against one or more other security risks of one or more other system architectures.

3. The method of claim 1, wherein the multi-layered graph comprises one or more vertices representing the hardware and software components, one or more edges representing actual or possible interactions between the hardware and software components, and one or more layers representing one or more levels of abstraction of the hardware and software components.

4. The method of claim 3, further comprising:
identifying one or more vulnerabilities and one or more countermeasures of the system architecture.

5. The method of claim 4, wherein the one or more vulnerabilities comprise at least one of the vertices representing a potential attack surface and at least one of the edges representing a potential attack path.

6. The method of claim 4, further comprising:
including one or more isolation layers in the multi-layered graph.

7. The method of claim 6, further comprising:
reassessing the one or more security metrics after the one or more vulnerabilities and the one or more countermeasures are identified.

8. The method of claim 1, wherein the security risk analysis is automated.

9. A system for security risk analysis, comprising:
at least one processor; and
a non-transitory processor-readable memory device storing instructions that when executed by the at least one processor causes the at least one processor to perform operations including:
identifying hardware and software components of a system architecture;
generating a multi-layered graph based on the hardware and software components, wherein the multi-layered graph includes a hardware layer representing a lowest level of hardware architecture of the system architecture;
extracting one or more properties of the multi-layered graph;
computing one or more security metrics based on the one or more properties; and
quantifying a security risk of the system architecture based on the one or more security metrics.

10. The system of claim 9, wherein the operations further comprise:
comparing the security risk of the system architecture against one or more other security risks of one or more other system architectures.

11. The system of claim 9, wherein the multi-layered graph comprises one or more vertices representing the hardware and software components, one or more edges representing actual or possible interactions between the hardware and software components, and one or more layers representing one or more levels of abstraction of the hardware and software components.

12. The system of claim 11, wherein the operations further comprise:
identifying one or more vulnerabilities and one or more countermeasures of the system architecture.

13. The system of claim 12, wherein the one or more vulnerabilities comprise at least one of the vertices representing a potential attack surface and at least one of the edges representing a potential attack path.

14. The system of claim 12, wherein the operations further comprise:
including one or more isolation layers in the multi-layered graph.

15. The system of claim 14, wherein the operations further comprise:
reassessing the one or more security metrics after the one or more vulnerabilities and the one or more countermeasures are identified.

16. A computer program product for security risk analysis, the computer program product comprising a computer readable storage medium having program instructions embodied therewith, the program instructions executable by a processor to cause the processor to:
identify hardware and software components of a system architecture;
generate a multi-layered graph based on the hardware and software components, wherein the multi-layered graph includes a hardware layer representing a lowest level of hardware architecture of the system architecture;
extract one or more properties of the multi-layered graph;
compute one or more security metrics based on the one or more properties; and
quantify a security risk of the system architecture based on the one or more security metrics.

17. The computer program product of claim 16, wherein the program instructions executable by the processor further cause the processor to:
compare the security risk of the system architecture against one or more other security risks of one or more other system architectures.

18. The computer program product of claim 16, wherein the multi-layered graph comprises one or more vertices representing the hardware and software components, one or more edges representing actual or possible interactions between the hardware and software components, and one or more layers representing one or more levels of abstraction of the hardware and software components.

19. The computer program product of claim 18, wherein the program instructions executable by the processor further cause the processor to:
identify one or more vulnerabilities and one or more countermeasures of the system architecture;
wherein the one or more vulnerabilities comprise at least one of the vertices representing a potential attack surface and at least one of the edges representing a potential attack path.

20. The computer program product of claim 19, wherein the program instructions executable by the processor further cause the processor to:
include one or more isolation layers in the multi-layered graph; and
reassess the one or more security metrics after the one or more vulnerabilities and the one or more countermeasures are identified.
